(19) United States
(12) Patent Application Publication
(10) Pub. No.: US 2008/0300047 A1
(43) Pub. Date: Dec. 4, 2008

(54) Gaming Machine And Gaming System Allowing Purchase Of Credits By Means Of Card

(75) Inventor: Hiroyuki NAGANO, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE CORP., Tokyo (JP)

(21) Appl. No.: 12/119,923

(22) Filed: May 13, 2008

(30) Foreign Application Priority Data
May 30, 2007 (JP) 2007-143189

(51) Int. Cl. A63F 9/24; A63F 13/00

(52) U.S. Cl. 463/25

(57) ABSTRACT

A system for settling accounts at a casino includes a card issuing terminal, a credit writing device, a gaming machine, a card checkout terminal, and a card data management server. The card issuing terminal, the credit writing device, the gaming machine and the card checkout management server are communicatively connected with the card data management server, respectively. The card checkout terminal is configured to: perform a comparison between a first set of player identification and credit amount data included in card data received from the card data management server and a second set of player identification and credit amount data stored in a card; and when matching between the first set and the second set is confirmed, settle accounts.

This application is based on and claims the benefit of priority from Japanese Patent Application No. 2007-143189, filed on 30 May 2007, the content of which is incorporated. herein by reference.

### BACKGROUND OF THE INVENTION

1. Field of the Invention

The present invention relates to a gaming machine and a gaming system allowing purchase of credit using a card.

2. Related Art

Conventionally, a slot machine, which is a type of gaming machine, is configured so as to: start a game upon insertion of gaming media such as coins; display columns of symbols variably in a predetermined region of the gaming machine and then statically after a predetermined amount of time; and provide an award in accordance with a combination of symbols statically displayed. A combination is typically regarded as entitled to an award, in cases in which a predetermined number of the same symbols (for example, “CHERRY” or “7”) are aligned on a predetermined winning line. A player is required to purchase credit to play a game. U.S. Patent Application Publication No. 2006/0135246 (hereinafter referred to as Patent Document 1) discloses a slot machine which allows a player to purchase of credit by inserting a coin into a coin insertion slot.

However, with the slot machine disclosed in Patent Document 1, the player must insert coins one by one. Moreover, since the player must carry coins to another gaming machine to play a game therewith, she feels inconvenience. Additionally, the player, who must carry cash in a casino to purchase the coins, might possibly encounter a robbery.

### SUMMARY OF THE INVENTION

The present invention provides a casino checkout machine with a gaming machine and the like, which provide improved entertainment properties.

In an aspect of the present invention, a system for settling accounts at a casino is provided, which includes a card issuing terminal, a credit writing device, a gaming machine, a card checkout terminal, and a card data management server. The card issuing terminal issues a card. The credit writing device, the gaming machine, and the card checkout terminal are communicable with the card. The card issuing terminal, the credit writing device, the gaming machine and the card checkout management server are communicatively connected with the card data management server, respectively. The card has a memory area sufficient for storing at least a player identification to identify a player and credit amount data corresponding to the player identification. The card issuing terminal is configured to: cause the card to store information related to card identification including at least the player identification; issue the stored card; and transmit the information related to card identification to the card data management sever. The card writing device is configured to: receive the player identification from the card; write credit amount data into the card, the credit amount data being entered by a player or being in accordance with an amount of money provided by the player; and transmit the received player identification and the written credit amount data to the card data management server. The card data management server is configured to: have a first memory for storing card data that includes at least the player identification and the credit amount data; receive the information related to card identification from the card issuing terminal and cause the first memory to store the received information related to card identification; and receive the player identification and the credit amount data from the credit writing device and cause the first memory to store the received player identification and the received credit amount data. The gaming machine includes: a display device; a second memory for storing the credit amount data; a communication interface circuit configured to communicate with the card; an input device configured to allow a game to start in response to manipulation by a player; and a controller configured to: (a) determine whether communication is available with the card via the communication interface circuit; (b) when the communication is available, receive the player identification and the credit amount data and cause the second memory to store the received player identification and the received credit amount data; (c) start a game in response to manipulation applied to the input device by the player; (d) determine whether or not to provide an award according to a result of the game; (e) when an award is determined to be provided, perform an addition of an amount of credit in accordance with the award to the credit amount data stored in the second memory; (f) terminate the game in response to manipulation by the player and transmit the credit amount data stored in the second memory at a time of termination of the game to the card so as to update the credit amount data stored in the card; and (g) transmit the player identification and the credit amount data stored in the second memory at the time of the termination of the game to the card data management server. The card data management server is further configured to: receive the player identification and the credit amount data from the gaming machine and cause the first memory to store the received player identification and the received credit amount data; and transmit the card data to the card checkout terminal in response to an instruction to send the card data from the card checkout terminal. The card checkout terminal is configured to: perform a comparison between a first set of the player identification and the credit amount data included in the card data received from the card data management server and a second set of the player identification and the credit amount data stored in the card; and when matching between the first set and the second set is confirmed, settle accounts.

The system described above, which includes the credit writing device, allows the player to purchase credit with the card. In this way, since the system does not require the player to insert coins into the gaming machine, it allows her not to carry money with her.

In another aspect of the present invention, the system further includes an electrical locking device that is attached to a door of a guest room and communicable with the card. The electrical locking device performs locking and unlocking receiving a signal indicating the information related to card identification from the card.

The system described above, which has the electrical locking device, allows the player to purchase credit with the card that is used as a key (room key card).

In still another aspect of the present invention, the system further includes a product vending terminal communicable with the card. The product vending terminal is configured to: receive the player identification from the card; transmit an amount of credit consumed for purchase of a product by the player to the card so as to update the credit amount data stored in the card; and transmit the received player identification and the consumed amount of credit to the card data management server. The card data management server causes the first memory to store the player identification and the consumed amount of credit received from the product vending terminal.

The system described above, which has the product vending terminal, allows the player to purchase credit and products with the card that is used as a key (room key card).

In yet another aspect of the present invention, a system for settling accounts at a casino is provided, which includes a card issuing terminal, a credit writing device, a gaming machine, a card checkout terminal, a card data management server, and an order data management terminal. The card issuing terminal issues a card. The credit writing device, the gaming machine, and the card checkout terminal are communicable with the card. The card issuing terminal, the credit writing device, the gaming machine and the card checkout management server are communicatively connected with the card data management server and an order data management terminal, respectively. The card has a memory area sufficient for storing at least a player identification to identify a player and credit amount data corresponding to the player identification. The card issuing terminal is configured to: cause the card to store information related to card identification including at least the player identification; issue the stored card; and transmit the information related to card identification to the card data management sever. The card writing device is configured to: receive the player identification from the card; write credit amount data into the card, the credit amount data being entered by a player or being in accordance with an amount of money provided by the player; and transmit the received player identification and the written credit amount data to the card data management server. The card data management server is configured to: have a first memory for storing card data that includes at least the player identification and the credit amount data; receive the information related to card identification from the card issuing terminal and cause the first memory to store the received information related to card identification; and receive the player identification and the credit amount data from the credit writing device and cause the first memory to store the received player identification and the received credit amount data. The gaming machine includes: a display device; a first input device that transmits product data corresponding to an image of a product selected by a player from a plurality of images depicting a plurality of products displayed on the display device; a second memory for storing the credit amount data; a communication interface circuit. configured to communicate with the card; a second input device configured to allow a game to start in response to manipulation by a player; and a controller configured to: (a) determine whether communication is available with the card via the communication interface circuit; (b) when the communication is available, receive the player identification and the credit amount data and cause the second memory to store the received player identification and the received credit amount data; (c) start a game in response to manipulation applied to the second input device by the player; (d) determine whether or not to provide an award according to a result of the game; (e) when an award is determined to be provided, perform an addition of an amount of credit in accordance with the award to the credit amount data stored in the second memory; (f) cause the display device to display the image depicting the plurality of products at predetermined timing after a start of the game; (g) transmit order data including at least a machine identification to identify the gaming machine and the product data to the order data management terminal in response to reception of the product data from the first input device; (h) subtract an amount of credit corresponding to the received product data from the credit amount data stored in the second memory; (i) terminate the game in response to manipulation by the player and transmit the credit amount data stored in the second memory at a time of termination of the game to the card so as to update the credit amount data stored in the card; and (j) transmit the player identification and the credit amount data stored in the second-memory at the time of the termination of the game to the card data management server. The order data management terminal has a display device and causes the display device to display contents of the order data while receiving the order data from the gaming machine. The card data management server is further configured to: receive the player identification and the credit amount data from the gaming machine and cause the first memory to store the received player identification and the received credit amount data; and transmit the card data to the card checkout terminal in response to an instruction to send the card data from the card checkout terminal. The card checkout terminal is configured to: perform a comparison between a first set of the player identification and the credit amount data included in the card data received from the card data management server and a second set of the player identification and the credit amount data stored in the card; and when matching between the first set and the second set is confirmed, settle accounts.

The system described above allows the player to order her desired product by displaying an order window on the display device where the images of products are depicted, when she feels hungry or thirsty. In this way, since the player can eat or drink without leaving the gaming machine, the system allows her to have more enjoyable time.

In a further aspect of the present invention, the system further includes an electrical locking device that is attached to a door of a guest room and communicable with the card. The electrical locking device performs locking and unlocking, receiving a signal indicating the information related to card identification from the card.

The system described above allows the player to purchase credit for the game with a room key card. In addition, the system allows the player to order her desired product by displaying an order window where images of products are depicted when she feels hungry or thirsty. Since she can eat or drink without leaving the gaming machine on which she is playing a game, she has a chance to have a more enjoyable time.

The present invention provides a casino checkout machine with a gaming machine and the like with improved entertainment properties.

### BRIEF DESCRIPTION OF THE DRAWINGS

FIG. 1 is a block diagram illustrating a configuration of a casino checkout system according to the present invention;

FIG. 2 is a table showing contents of data stored in a card according to the present invention;

FIG. 3 is a table showing contents of data stored in a card data management server according to the present invention;

FIG. 4 is a table showing contents of data stored in a card according to the present invention;

FIG. 5 is a table showing contents of data stored in a card data management server according to the present invention;

FIG. 6 is a perspective view showing the appearance of the gaming machine according to the present invention;

FIG. 7 is an enlarged front view showing a display area of the gaming machine according to the present invention;

FIG. 8 is a block diagram of a controller of the gaming machine according to the present invention;

FIG. 9 is a block diagram of a display/input controller of the gaming machine according to the present invention;

FIG. 10 is a diagram showing a flow of processing executed in the gaming machine according to the present invention;

FIG. 11 is a diagram showing a flow of processing executed in the gaming machine according to the present invention;

FIG. 12 is a table showing contents of order data according to the present invention;

FIG. 13 is a diagram illustrating an example of a display window according to the present invention;

FIG. 14 is a diagram illustrating an example of a display window according to the present invention; and

FIG. 15 is a diagram illustrating an example of a display window according to the present invention.

### DETAILED DESCRIPTION OF THE INVENTION

An embodiment of the present invention is now described with reference to the drawings.

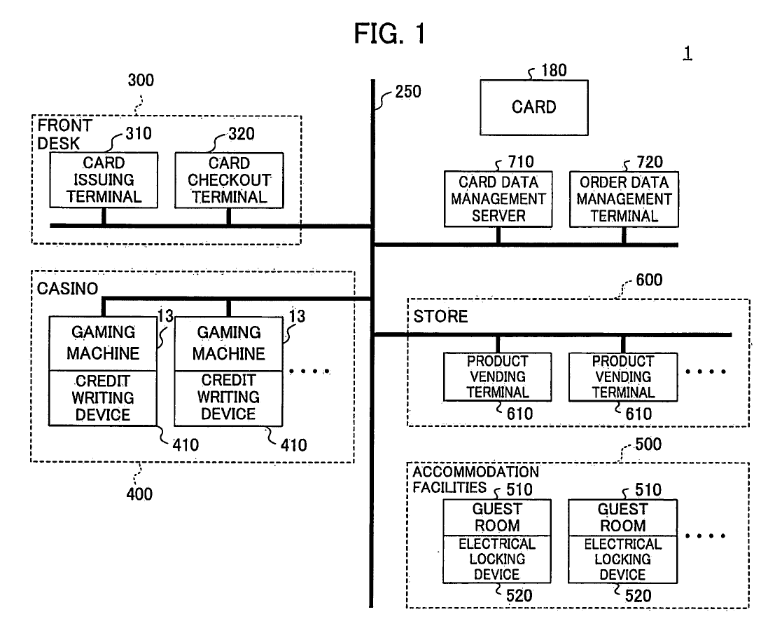

FIG. 1 is a block diagram illustrating a configuration of a casino checkout system 1 according to an embodiment of the present invention. The casino checkout system 1 is installed in a hotel. In FIG. 1, the casino checkout system 1 has a front desk 300, a casino 400, accommodations 500, a store 600, a card data management server 710, an order data management terminal 720 and a card 180. In addition, in the casino checkout system 1, the card data management server 710, the order data management terminal 720, a card issuing terminal 310, a card checkout terminal 320, a plurality of product vending terminals 610 and a plurality of gaming machines 13 are connected via a network 250. Furthermore, the card issuing terminal 310 and the card checkout terminal 320 are installed in the front desk 300; the plurality of product vending terminals 610 are installed in the store 600; and the plurality of gaming machines 13 are installed in the casino 400.

Each gaming machine 13 has a plurality of credit writing devices 410. In addition, the accommodations 500 include a plurality of guest rooms 510, which include a plurality of electrical locking devices 520, respectively.

A card 180 is issued by the card issuing terminal 310. Carrying the card 180, a player can play a game in the casino 400 and purchase products in the store 600.

Each time credit amount data stored in the card 180 is rewritten, the gaming machine 13 in the casino 400 and the product vending terminal 610 in the store 600 transmit the credit amount data to the card data management server 710. Accordingly, the card data management server 710 stores, for each player ID, the same credit amount data as is stored in the card 180.

The player can settle an account for the card 180 with the card checkout terminal 320. The card checkout terminal 320 compares the credit amount data stored in the card 180 to the credit amount data stored in the card data management server 710 corresponding to the player ID, and proceeds to checkout if the two data sets are identical. This can prevent damage caused by the falsified credit amount data in the card 180.

Components of the casino checkout system 1 are hereinafter described, respectively.

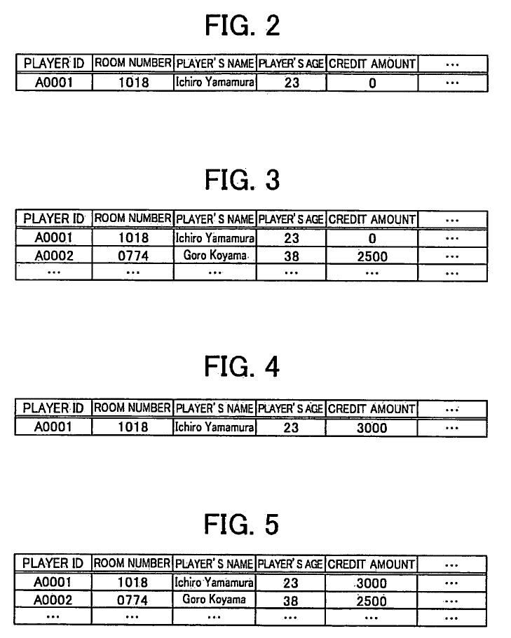

The card issuing terminal 310 issues the card 180. After issuing the card 180, the card issuing terminal 310 sends data (later described in FIG. 2) to the card data management server 710.

The card checkout terminal 320 compares the player ID and the credit amount data stored in the card 180 to those received from the card data management server 710, and proceeds to checkout if the two data sets are identical.

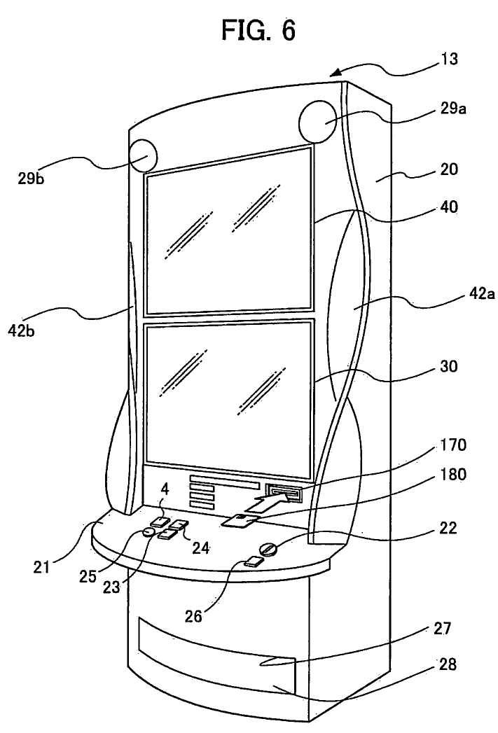

The gaming machine 13 installed in the casino 400 has a card slot 170 (see FIG. 6.). The player can communicably connect the card 180 to the gaming machine 13 via the card slot 170. Since the gaming machine 13 includes a credit writing device 410, the player can also communicate with the credit writing device 410 so as to download the credit amount data into a memory in the card 180.

It should be noted that, the credit writing device 410 may alternatively be separated from the gaming machine 13 as long as it has a card slot 170.

The product vending terminal 610 installed in the store 600 has a card slot (not shown). Insertion of the card 180 into the card slot allows the product vending terminal 610 to be communicable with the card 180. The product vending terminal 610 can thus write the credit amount data of the product into the memory in the card 180.

A guest room 510 in the accommodations 500 has an electrical locking device 520. The player can lock and unlock the electrical locking device 520 by way of the card 180.

The card data management server 710, which stores the same credit amount data as is stored in the card 180, receives the credit amount data associated with the player ID from the gaming machine 13, the credit writing device 410, and the product vending terminal 610. The card data management server 710 also sends the credit amount data associated with the player ID to the card checkout terminal 320.

The order data management terminal 720 receives order data including at least a machine ID and product data from the gaming machine 13, and displays contents of the received order data on a display device. This allows for identification of the machine used by a player playing the game and delivery of the ordered product to the player.

FIG. 2 is a table showing contents of the data stored in the card 180 at a time of issuance by the card issuing terminal 310. According to FIG. 2, the card 180 has a storage area sufficient for storing at least a player ID, a room number for identifying a guest room, a player's name, a player's age, and credit amount data. For example, the player ID is “A0001”; the room number is “1018”; the player's name is “Ichiro Yamamura”; the player's age is “23”; and the credit amount is “0”. The credit amount is “0” because no credit amount data has been written at the time of issuance. In addition, after issuing the card 180, the card issuing terminal 310 sends data including at least the player ID, the room number, the player's name, the player's age, and the credit amount data to the card data management server 710. Here, key data for locking and unlocking the electrical locking device 520 is a combination of the player ID and the room number. The key data may alternatively be the room number alone.

FIG. 3 shows a table that depicts contents of data stored in the card data management server 710 at a time of issuance of a card 180, in which the card issuing terminal 310 stores a player ID “A0001”. According to FIG. 3, the card data management server 710 stores data for each player ID including at least a room number, a player's name, a player's age, and credit amount data. Since the card issuing terminal 310 has sent data including at least the player ID, the room number, the player's name, the player's age, and the credit amount data to the card data management server 710 at the time of issuance of the card 180, data corresponding to the player ID “A0001” has been added.

FIG. 4 is a table showing contents of the data stored in the card 180 storing the player ID “A0001”, at a time of the credit amount data being written by the credit writing device 410. The credit amount of “0” in FIG. 2 has changed to “3000” in FIG. 4. A credit amount input device (not shown), which is attached to the credit writing device 410, allows the player to input a desired amount of credit to purchase. Since a cash slot (not shown) is also attached to the credit writing device 410, it can write credit amount data into the card 180 in accordance with the amount of cash inserted by the player through the cash slot.

FIG. 5 is a table showing contents of the data stored in the card data management server 710, at a time of the credit amount data being written into the card 180 storing the player ID “A0001” by the credit writing device 410. Since the credit writing device 410 sends data including at least the player ID, the room number, the player's name, the player's age, and the credit amount data to the card data management server 710 at the time of the credit amount data being written into the card 180, data corresponding to the player ID “A0001” has been added.

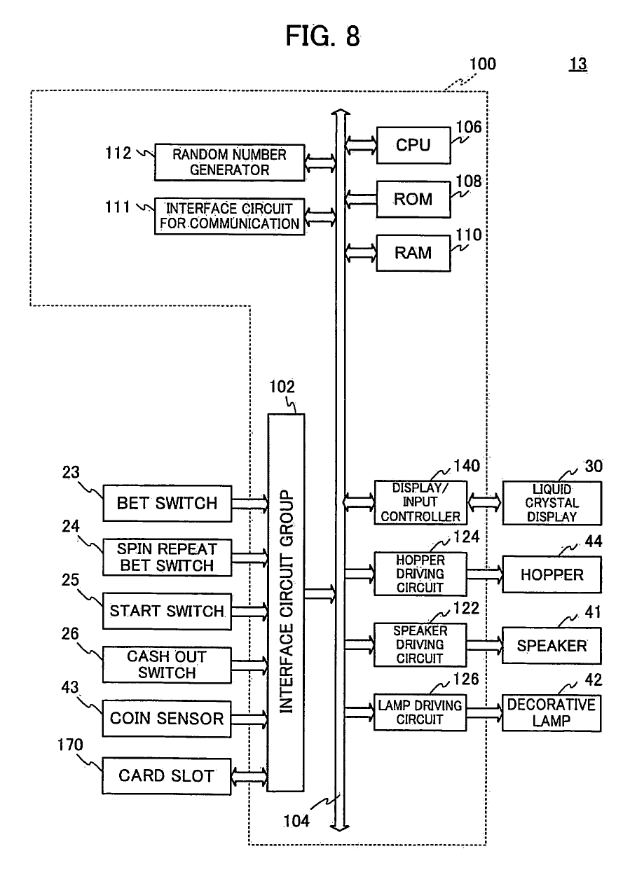

FIG. 6 is a perspective view illustrating the gaming machine 13 according to an embodiment of the present invention. The gaming machine 13 includes a cabinet 20. A surface of the cabinet 20, which faces the player, is made to be open. The cabinet 20 houses various components including a controller 100 (refer to FIG. 8) for electrically controlling the slot machine 13, and a hopper 44 (refer to FIG. 8) for controlling the insertion, storage, and payout of coins (game media), and the like. The game media are not limited to coins, and for example, may include medals, tokens, electronic money, or information of electronic value (credit) equivalent thereto.

A liquid crystal display 30 is disposed at substantially the center of the front face of the cabinet 20, and a liquid crystal display 40 is disposed above the display 30.

The liquid crystal display 30 realizes a display device for displaying a variety of images related to the game, including rendered images and the like. The player advances the game while visually recognizing the variety of images displayed on the liquid crystal display 30. In such a game, the liquid crystal display 30 displays a slot game.

The gaming machine 13, which employs video reels, causes the liquid crystal display 30 to display five virtual reels. It should be noted that the video reels are reels to be displayed as images on the liquid crystal display 30 in place of mechanical reels. As a plurality of types of necessary symbols for the game, the following symbols are displayed as imaginarily spinning images: “BONUS”, “WILD”, “TREASURE BOX”, “GOLDEN MASK”, “HOLY GRAIL”; “COMPASS&MAP”, “SNAKE”, “A”, “K”, “Q”, “J”, and “10”.

The other liquid crystal display 40 above the liquid crystal display 30 serves as a sub display for displaying the: rules of the game, demonstration screens, and the like.

Sound permeable openings 29a and 29b, through which sound effects emitted from a speaker 41 (refer to FIG. 8) contained inside the cabinet 20 are propagated outside the cabinet 20, are disposed on the upper right and left sides of the liquid crystal display 40, respectively. The sound effects can be emitted through the sound permeable openings 29a and 29b in accordance with the progress of the game or the like. Decorative lamps 42a and 42b are disposed on the right and left sides in the middle of the gaming machine 13, respectively. The decorative lamps 42a and 42b emit light in accordance with the progress of the game.

The card slot 170 is provided below an operation unit 21 below the liquid crystal display 30. The card slot 170 is configured so as to be connectable to the card 180.

Additionally, a substantially horizontal operation unit 21 is provided below the liquid crystal display 30. Disposed on the right side of the operation unit 21 is a coin slot 22 through which coins are inserted into the gaming machine 13. On the other hand, the components provided on the left side of the operation unit 21 include: a BET switch 23 that allows a player to determine which lines are to be activated, among nine lines L1, L2, L3, L4, L5, L6, L7, L8, and L9, for providing an award described later (which will simply be referred to as “winning lines” hereafter), and which allows the player to select the number of coins as gaming media which are to be bet on the aforementioned active pay lines; a spin repeat bet switch 24 that allows the player to play the game again without changing the number of coins bet on the aforementioned active pay lines from that in the immediately prior game. The number of coins to be bet on the abovementioned winning lines can be decided by pressing the BET switch 23 or the spin repeat bet switch 24.

On the operation unit 21, a start switch 25 for accepting each game with the player's operation for starting a game is disposed on the left side of the bet switch 23. Pressing either the start switch 25 or the spin repeat bet switch 24 triggers the start of the game, and then an image in which the aforementioned five image reels 3A to 3E start to spin is displayed.

On the other hand, a cash out switch 26 is provided near the coin slot 22 in the aforementioned operation unit 21. When the player presses the cash out switch 26, the inserted coins are discharged from a coin discharge slot 27, which is an opening located in a lower part of the front face of the cabinet 20. The discharged coins are accumulated on a coin tray 28.

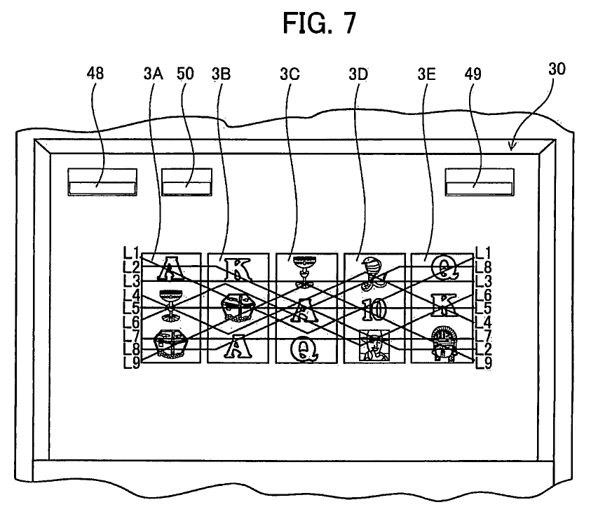

FIG. 7 is an enlarged view of the display area of the gaming machine 13. As shown in FIG. 7, the gaming machine 13 has the lines L1 to L9 for providing nine awards. The lines L1 to L9 extend so as to pass through a symbol on each of the video reels 3A to 3E when the images of the spinning five video reels 3A to 3E come to a stop.

When the above-described BET switch 23 is pressed once, for example, the line L3 for providing the third award, the line L5 for giving the fifth award, and the line L7 for giving the seventh award are validated, and one coin is received as a credit medal.

When the above-described BET switch 23 is pressed twice, in addition to the above-described three lines, for example, the line L1 for giving the first award, the line L4 for giving the fourth award, and the line L8 for giving the eighth award are validated, and two coins are collected as credit medals. When the above-described BET switch 23 is pressed three times, in addition to the above-described six lines, for example, the line L2 for giving the second award, the line L6 for giving the sixth award, and the line L9 for giving the ninth award are validated, and three coins are collected as the credit medals.

Any type of game is available in the present embodiment as long as a game employs predetermined combinations of symbols arranged along winning lines.

A payout number display portion 48, a bet number display portion 50, and a credit number display portion 49 are configured to be displayed in this order from the left on the upper portion of the liquid crystal display 30. The payout number display portion 48 displays the payout number of coins when a combination for providing an award is achieved along a winning line. The credit number display portion 49 displays the credit number of coins stored in the gaming, machine 13. The bet number display portion 50 displays the bet number indicating the number of coins bet on the winning lines.

FIG. 8 is a block diagram illustrating the electrical configuration of the game controller 100 of the gaming machine 13. Referring to FIG. 8, the game controller 100 of the gaming machine 13 is a microcomputer including an interface circuit group 102, an input-output bus 104, a CPU 106, ROM 108, RAM 110, an interface circuit 111 for communication, a random number generator 112, a speaker driving circuit 122, a hopper driving circuit 124, a lamp driving circuit 126, and a display/input controller 140.

The interface circuit group 102 is connected with the input/output bus 104, which inputs and outputs data signals and address signals to the CPU 106.

The start switch 25 is connected with the interface circuit group 102. A start signal output from the start switch 25 is converted into a predetermined form of signal in the interface circuit group 102, and is then supplied to the input/output bus 104.

The BET switch 23, the spin repeat bet switch 24, and the cash out switch 26 are also connected to the interface circuit group 102. Each of the switching signals output from these switches 23, 24, and 26 is also supplied to the interface circuit group 102 and converted into a predetermined form of signal by the interface circuit group 102, and is then supplied to the input/output bus 104.

A coin sensor 43 is also connected to the interface circuit group 102. The coin sensor 43 is a sensor for detecting coins inserted into the coin slot 22, and is provided in association with the coin slot 22. A sensing signal output from the coin sensor 43 is also supplied to the interface circuit group 102, converted into a predetermined signal by the interface circuit group 102, and is then supplied to the input/output bus 104.

The card slot 170 is also connected to the interface circuit group 102. The connection between the card slot 170 and the card 180 allows for communication between the card 180 and the gaming machine 13.

The ROM 108 and RAM 110 are connected to the input/output bus 104.

Upon acceptance of the start operation of a game through the start switch 25, the CPU 106 reads a game program to execute the game. The game program is programmed so as to: start displaying the scrolling of the symbols on the five video reels on the liquid crystal display 30 via the display/input controller 140, and display the five video reels statically, thereby rearranging the five video reels; and, if a combination of the stationary symbols is displayed along a winning line and the combination corresponds to a specific combination for providing an award, pay out an amount of coins corresponding to the specific combination.

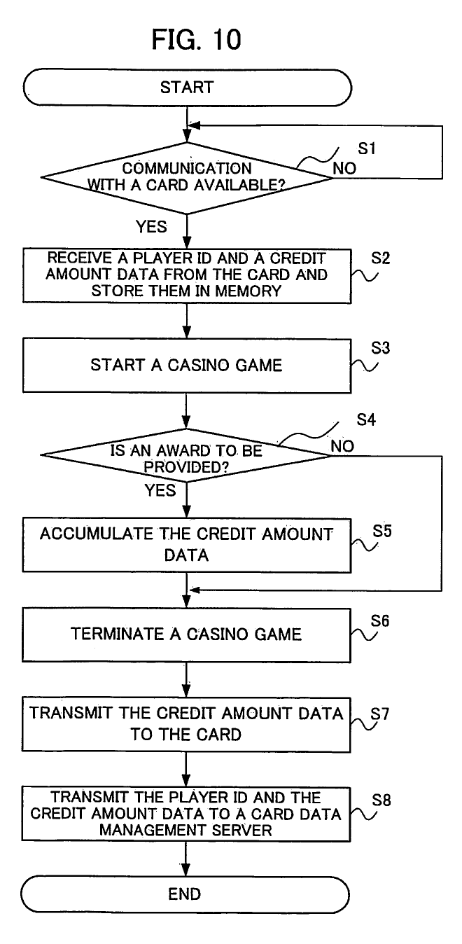

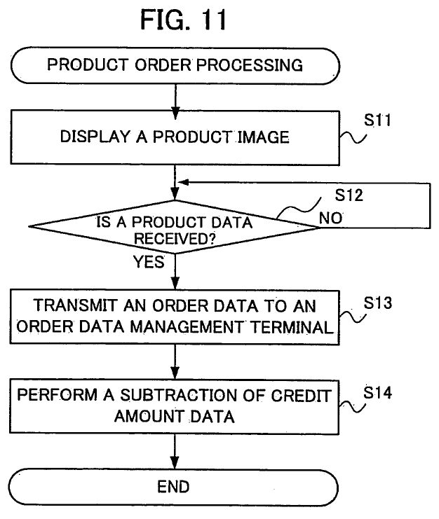

The ROM 108 stores a control program for comprehensively controlling the gaming machine 13, a program for executing routines shown in FIGS. 10 and 11 (hereinafter referred to as a “routine execution program”), and initialization data for executing the control program, and various data tables used in decision processes. The routine execution program includes the abovementioned game program. The RAM 110 temporarily stores flags, values of variables and the like used in the abovementioned control program.

The communication interface circuit 111 is also connected to the input/output bus 104. The communication interface circuit 111 is a circuit for communicating with a central controller 11 and the like via a network 12 including various kinds of networks such as LAN.

The random number generator 112 is also connected to the input/output bus 104. The random number generator 112 generates random numbers in a predetermined range of numeric values, for example 0 to 65535 (2¹⁶−1). Alternatively, the CPU 106 may generate random numbers by computation.

A speaker driving circuit 122 for driving a speaker 41 is also connected to the input/output bus 104. The CPU 106 reads out sound data stored in the ROM 108 and transmits the sound data to the speaker driving circuit 122 via the input/output bus 104. In this way, the speaker 41 generates sound effects.

A hopper driving circuit 124 for driving the hopper 44 is also connected to the input/output bus 104. Upon receiving a cash out signal input by the cash out switch 26, the CPU 106 outputs a drive signal to the hopper driving circuit 124 via the input/output bus 104. The hopper 44 thus pays out an amount of coins corresponding to the current remaining credit as stored in a predetermined memory area of the RAM 110.

Alternatively, the payout of the coins may be performed through storing the credit amount data in a data card, instead of using physical coins. That is, the player may carry a card functioning as a recording medium, and store the data related to the credit by inserting the card into the gaming machine 13.

The lamp driving circuit 126 for driving the decorative lamps 42a and 42b is also connected to the input-output bus 104. The CPU 106 sends a signal for driving the lamps to the lamp driving circuit 126 under a predetermined condition, based on the program stored in the ROM 108. In this way, the decorative lamps 42a and 42b flicker.

The display/input controller 140 is also connected to the input/output bus 104. The CPU 106 generates an image display instruction in accordance with the game state and the result of the game, and outputs the generated image display instructions to the display/input controller 140 via the input-output bus 104. Upon receiving the image display instruction from the CPU 106, the display/input controller 140 generates a drive signal for driving the liquid crystal display 30 based on the image display instruction thus received, and outputs the generated drive signal to the liquid crystal display 30. A predetermined image is thus displayed on the liquid crystal display 30. In addition, the display/input controller 140 transmits the signal, which is input through the touch panel 32 provided on the liquid crystal display 30, to the CPU 106 via the input/output bus 104 as an input signal. The image display instruction also includes instructions in accordance with the payout number display portion 48, the credit number display portion 49, and the bet number display portion 50.

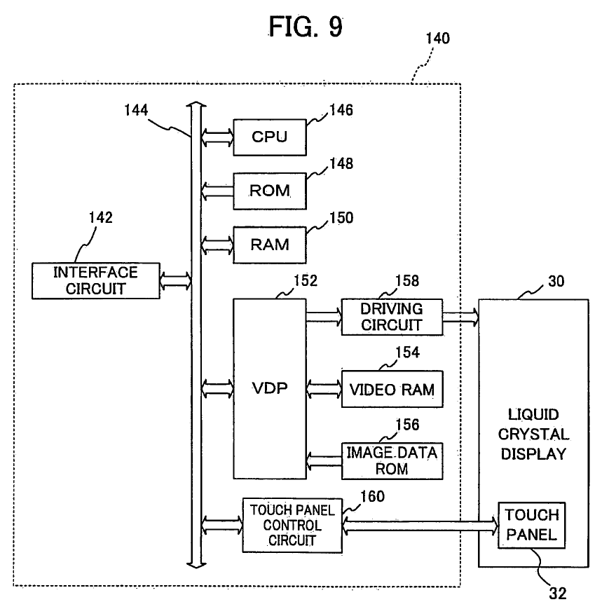

FIG. 9 is a block diagram illustrating an electrical configuration of the display/input controller 140 of the gaming machine 13. The display/input controller 140 of the gaming machine 13 is a sub-microcomputer for performing image display processing and input control for the touch panel 32. The display/input controller 140 includes an interface circuit 142, an input/output bus 144, a CPU 146, ROM 148, RAM 150, a VDP 152, video RAM 154, image data ROM 156, a driving circuit 158, and a touch panel control circuit 160.

The interface circuit 142 is connected to the input/output bus 144. An image display instruction output from the CPU 106 on the abovementioned game controller 100 is supplied to the input/output bus 144 via the interface circuit 142. The input/output bus 144 receives and outputs a data signal or an address signal from and to the CPU 146.

The ROM 148 and the RAM 150 are connected to the input/output bus 144. The ROM 148 stores a display control program for generating a driving signal, which is to be supplied to the liquid crystal display 30, according to an image display instruction received from the CPU 106 of the aforementioned game controller 100. On the other hand, in the RAM 150, flags, values of variables, and the like for use in the abovementioned display control program are stored.

The VDP 152 is also connected to the input/output bus 144. The VDP 152 is a processing device including a so-called sprite circuit, a screen circuit, a palette circuit and the like, and is capable of performing a various kinds of processing for displaying an image on the liquid crystal display 30. The video RAM 154 and the image data ROM 156 are connected to the VDP 152. The video RAM 154 stores image data based on the image display instructions from the CPU 106 on the game controller 100. The image data ROM 156 stores various kinds of image data including the abovementioned effect image data and the like. Moreover, the VDP 152 is also connected to the driving circuit 158 outputting a drive signal for driving the liquid crystal display 30.

By reading and executing the display control program stored in the ROM 148, the CPU 146 instructs the video RAM 154 to store image data to be displayed on the liquid crystal display 30 in response to the image display instruction from the CPU 106 on the abovementioned game controller 100. The image display instruction includes various kinds of image display instructions, including an instruction for displaying the abovementioned rendered image.

The image data ROM 156 stores a variety of image data including the data of the abovementioned rendered image and the like.

The touch panel control circuit 160 transmits a signal being input on the touch panel 32 on the liquid crystal display 30, as an input signal, to the CPU 106 via the input/output bus 144.

FIG. 10 is a flow chart illustrating a flow of the processing operation of the gaming machine 13, which is executed by the game controller 100 of the gaming machine 13.

In Step S1, the CPU 106 determines whether communication with the card is possible. More specifically, the CPU 106 determines whether the communication with the card 180 is possible via the card slot 170. When the communication is possible, the CPU 106 advances the processing to Step S2. If not, the CPU 106 returns the processing to Step S1.

In Step S2, the CPU 106 receives the player ID and the credit amount data from the card 180, and stores them in the memory. More specifically, the CPU 106 receives the player ID and the credit amount data from a storage area in the card 180, and stores them in a predetermined area in the RAM 110. The CPU 106 advances the processing to Step S3.

In Step S3, the CPU 106 starts a casino game, and advances the processing to Step S4. More specifically, the CPU 106 starts the casino game in response to detection of pressing of the start switch 25. The casino game includes, for example, a slot game.

In Step S4, the CPU 106 determines whether an award is to be provided in accordance with a play result of the casino game. More specifically, the CPU 106 determines, for example, whether a predetermined number of symbols are aligned on a winning line. When the CPU 106 determines an award to be provided, it advances the processing to Step S5. If not, the CPU 106 advances the processing to Step S6.

In Step 5, the CPU 106 accumulates the credit amount data. More specifically, the CPU 106 adds an amount of credit corresponding to the award to the credit amount data stored in the RAM 110.

In Step S6, the CPU 106 terminates the casino game, and advances the processing to Step S7. More specifically, the CPU 106 terminates the casino game in response to detection of pressing of the termination switch (not shown).

In Step S7, the CPU 106 transmits the credit amount data to the card 180. More specifically, the CPU 106 transmits the credit amount data stored in the RAM 110 to the card 180 at a time of terminating the casino game. This processing allows the credit amount data stored in the card 180 to be updated. Afterwards, the CPU 106 advances the processing to Step S8.

In Step S8, the CPU 106 transmits the player ID and the credit amount data to the card data management server 710. More specifically, the CPU 106 transmits the player ID and the credit amount data stored in the RAM 110 to the card data management server 710 at the time of terminating the casino game. This processing allows the credit amount data, which corresponds to the player ID in the card data management server 710, not only to be updated but also to be synchronized with the credit amount data in the card 180. Upon finishing this processing, the CPU 106 terminates the routine.

FIG. 11 is a flow chart illustrating a flow of product order processing in the gaming machine 13, which is executed by the game controller 100 of the gaming machine 13. The product order processing is executed at predetermined timing between the beginning of the casino game (Step S3 in FIG. 10) and the end of the casino game (Step S6 in FIG. 10). The predetermined timing is a moment at which an operation is detected via the touch panel 32 for a button for calling a window to order products (not shown) or a button for calling a window to request music (not shown) on the liquid crystal display 30.

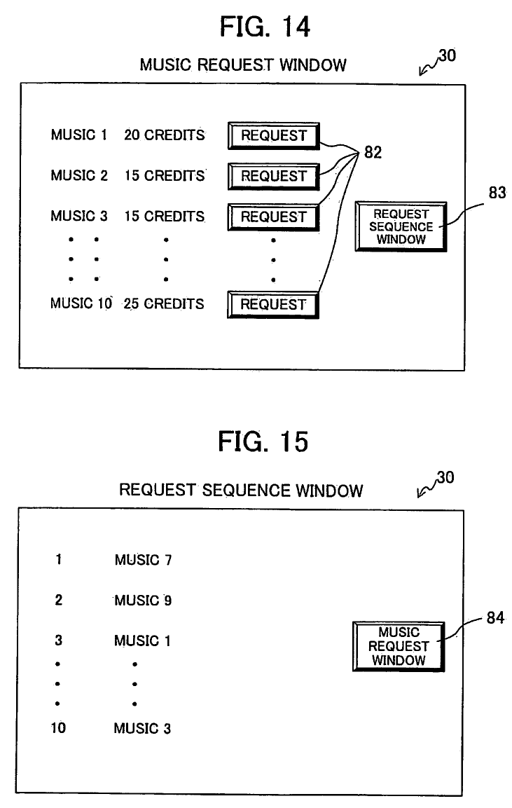

In Step S11, the CPU 106 performs processing for displaying product images. More specifically, the CPU 106 causes the liquid crystal display 30 to display the window for ordering products (see FIG. 13) or the window for requesting music (see FIG. 14) via the display/input controller 140. Afterwards, the CPU 106 advances the processing to Step S12.

In Step S12, the CPU 106 determines whether product data has been received. More specifically, the CPU 106 determines whether product data has been received corresponding to an order button 81 (see FIG. 14) or a request button 82 (see FIG. 15), that has been operated via the touch panel 32. When the CPU 106 recognizes reception of the product, the CPU 106 advances the processing to Step S13. If not, the CPU 106 advances the processing to Step S12.

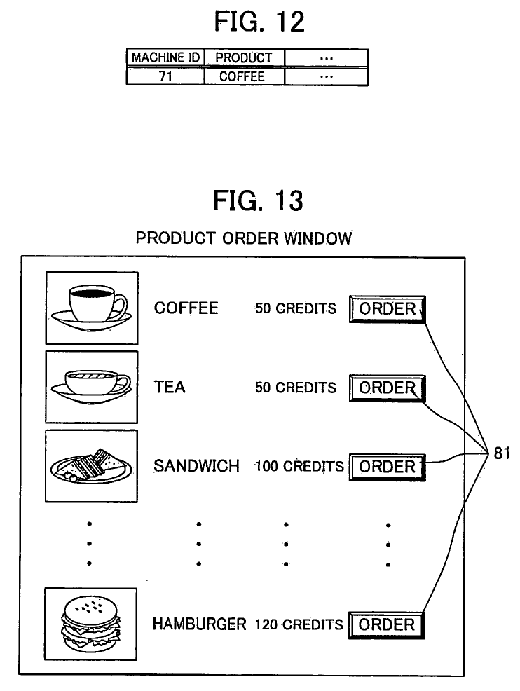

In Step S13, the CPU 106 transmits the order data to an order data management terminal 720. More specifically, the CPU 106 transmits the order data (see FIG. 12), including a machine ID and product data at the minimum, to the order data management terminal 720. Afterwards, the CPU 106 advances the processing to Step S14.

In Step S14, the CPU 106 performs processing for subtraction of credit amount data. More specifically, the CPU 106 subtracts the credit amount data corresponding to the product data from the credit amount data stored in the RAM 110. Upon finishing this processing, the CPU 106 terminates the routine.

FIG. 12 is a diagram illustrating order data. The order data, which the order data management terminal 720 has received from the gaming machine 13, is displayed on a display device (not shown) provided in the order data management terminal 720. According to FIG. 12, the order data includes at least a machine ID and product data. In this way, the data displayed on the display device allows a casino to know which product is ordered in conjunction with identification of a machine. FIG. 12 shows that “coffee” has been ordered from a gaming machine with a machine ID “71”.

Therefore, a player can be free from inconveniences caused by leaving the machine or waiting for a food cart to pass by while placing an order. In addition, since this can allow the casino to prepare the product after confirming the order data, it is possible to avoid waste such as preparing food and drinks ahead of time.

FIG. 13 is a diagram illustrating the window for ordering products. According to FIG. 13, product images and credit amounts are related to each other, and order buttons 81 are related to the product images. For example, “coffee” is related to “50 credits”.

FIG. 14 is a diagram illustrating the window for requesting music. According to FIG. 14, music titles and credit amounts are related to each other, and request buttons 82 are related to the music titles. For example, “Music 1” is related to “20 credits”. Moreover, by operating a button 83 for a request sequence window, the request sequence window as shown in FIG. 15 is displayed.

FIG. 15 is a diagram illustrating the request sequence window. According to FIG. 15, a sequence of requested music titles is displayed. For example, Music 1 is in the third place. This window allows the player to know when the music requested will be played. In addition, by operating a button 84 for a music request window, the music request window is displayed.

The gaming machine 13 and the card 180 can communicate with each other via the card slot 170 in the present embodiment; however, it should be noted that the present invention is not limited thereto, and a wireless transmission/reception part can be provided to the gaming machine 13 and the gaming machine 13 can thereby communicate with the card 180 via the wireless transmission/reception part.

It may alternatively be possible that an upper limit is set for the credit amount data, which is stored in the card 180 by the credit writing device 410. This can prevent the transfer of credit amount data exceeding the upper limit.

In addition, although a description has been provided regarding a slot game as the casino game in the present embodiment, the present invention is not limited thereto. The casino game can also be a card game, roulette, or the like.

While the preferred embodiment of the present invention has been described above, it is apparent to one skilled in the art that various changes and modifications can be made without departing from the scope of the amended claims.

What is claimed is:

1. A system for settling accounts at a casino, comprising:
a card issuing terminal for issuing a card;
a credit writing device communicable with the card;
a gaming machine communicable with the card;
a card checkout terminal communicable with the card; and
a card data management server with which the card issuing terminal, the credit writing device, the gaming machine and the card checkout management server are communicatively connected, respectively,
wherein the card has a memory area sufficient for storing at least a player identification to identify a player and credit amount data corresponding to the player identification,
wherein the card issuing terminal is configured to: cause the card to store information related to card identification including at least the player identification; issue the stored card; and transmit the information related to card identification to the card data management sever,
wherein the card writing device is configured to: receive the player identification from the card; write credit amount data into the card, the credit amount data being entered by a player or being in accordance with an amount of money provided by the player; and transmit the received player identification and the written credit amount data to the card data management server,
wherein the card data management server is configured to: have a first memory for storing card data that includes at least the player identification and the credit amount data; receive the information related to card identification from the card issuing terminal and cause the first memory to store the received information related to card identification; and receive the player identification and the credit amount data from the credit writing device and cause the first memory to store the received player identification and the received credit amount data,
wherein the gaming machine includes:
a display device;
a second memory for storing the credit amount data;
a communication interface circuit configured to communicate with the card;
an input device configured to allow a game to start in response to manipulation by a player; and a controller configured to:
(a) determine whether communication is available with the card via the communication interface circuit;
(b) when the communication is available, receive the player identification and the credit amount data and cause the second memory to store the received player identification and the received credit amount data;
(c) start a game in response to manipulation applied to the input device by the player;
(d) determine whether or not to provide an award according to a result of the game;
(e) when an award is determined to be provided, perform an addition of an amount of credit in accordance with the award to the credit amount data stored in the second memory;
(f) terminate the game in response to manipulation by the player and transmit the credit amount data stored in the second memory at a time of termination of the game to the card so as to update the credit amount data stored in the card, and
(g) transmit the player identification and the credit amount data stored in the second memory at the time of the termination of the game to the card data management server,
wherein the card data management server is further configured to: receive the player identification and the credit amount data from the gaming machine and cause the first memory to store the received player identification and the received credit amount data; and transmit the card data to the card checkout terminal in response to an instruction to send the card data from the card checkout terminal, and
wherein the card checkout terminal is configured to: perform a comparison between a first set of the player identification and the credit amount data included in the card data received from the card data management server and a second set of the player identification and the credit amount data stored in the card; and when matching between the first set and the second set is confirmed, settle accounts.

2. The system according to claim 1, further comprising an electrical locking device that is attached to a door of a guest room and communicable with the card,
wherein the electrical locking device performs locking and unlocking, receiving a signal indicating the information related to card identification from the card.

3. The system according to claim 2, further comprising a product vending terminal communicable with the card,
wherein the product vending terminal is configured to: receive the player identification from the card; transmit an amount of credit consumed for purchase of a product by the player to the card so as to update the credit amount data stored in the card; and transmit the received player identification and the consumed amount of credit to the card data management server, and
wherein the card data management server causes the first memory to store the player identification and the consumed amount of credit received from the product vending terminal.

4. A system for settling accounts at a casino, comprising:
a card issuing terminal for issuing a card;
a credit writing device communicable with the card;
a gaming machine communicable with the card;
a card checkout terminal communicable with the card;
a card data management server; and
an order data management terminal,
wherein the card issuing terminal, the credit writing device, the gaming machine and the card checkout management server are communicatively connected with the card data management server and an order data management terminal, respectively,
wherein the card has a memory area sufficient for storing at least a player identification to identify a player and credit amount data corresponding to the player identification,
wherein the card issuing terminal is configured to: cause the card to store information related to card identification including at least the player identification; issue the stored card; and transmit the information related to card identification to the card data management sever,
wherein the card writing device is configured to: receive the player identification from the card; write credit amount data into the card, the credit amount data being entered by a player or being in accordance with an amount of money provided by the player; and transmit the received player identification and the written credit amount data to the card data management server,
wherein the card data management server is configured to: have a first memory for storing card data that includes at least the player identification and the credit amount data; receive the information related to card identification from the card issuing terminal and cause the first memory to store the received information related to card identification; and receive the player identification and the credit amount data from the credit writing device and cause the first memory to store the received player identification and the received credit amount data,
wherein the gaming machine includes:
a display device;
a first input device that transmits product data corresponding to an image of a product selected by a player from a plurality of images depicting a plurality of products displayed on the display device;
a second memory for storing the credit amount data;
a communication interface circuit configured to communicate with the card;
a second input device configured to allow a game to start in response to manipulation by a player; and a controller configured to:
(a) determine whether communication is available with the card via the communication interface circuit;
(b) when the communication is available, receive the player identification and the credit amount data and cause the second memory to store the received player identification and the received credit amount data;
(c) start a game in response to manipulation applied to the second input device by the player;
(d) determine whether or not to provide an award according to a result of the game;
(e) when an award is determined to be provided, perform an addition of an amount of credit in accordance with the award to the credit amount data stored in the second memory;
(f) cause the display device to display the plurality of images depicting the plurality of products at predetermined timing after a start of the game;
(g) transmit order data including at least a machine identification to identify the gaming machine and the product data to the order data management terminal in response to reception of the product data from the first input device;
(h) subtract an amount of credit corresponding to the received product data from the credit amount data stored in the second memory;
(i) terminate the game in response to manipulation by the player and transmit the credit amount data stored in the second memory at a time of termination of the game to the card so as to update the credit amount data stored in the card; and
(j) transmit the player identification and the credit amount data stored in the second memory at the time of the termination of the game to the card data management server,
wherein the order data management terminal has a display device and causes the display device to display contents of the order data while receiving the order data from the gaming machine,
wherein the card data management server is further configured to: receive the player identification and the credit amount data from the gaming machine and cause the first memory to store the received player identification and the received credit amount data; and transmit the card data to the card checkout terminal in response to an instruction to send the card data from the card checkout terminal, and
wherein the card checkout terminal is configured to: perform a comparison between a first set of the player identification and the credit amount data included in the card data received from the card data management server and a second set of the player identification and the credit amount data stored in the card; and when matching between the first set and the second set is confirmed, settle accounts.

5. The system according to claim 4, further comprising an electrical locking device that is attached to a door of a guest room and communicable with the card,
wherein the electrical locking device performs locking and unlocking, receiving a signal indicating the information related to card identification from the card.
